(19) United States
(12) Patent Application Publication
(10) Pub. No.: US 2005/0074523 A1
(43) Pub. Date: Apr. 7, 2005

(54) Flavoured/aromatized ice cubes, a method for their production, and the use of the ice cubes produced

(76) Inventor: Pedro Pablo Rodriguez Santos, Los Ramos (ES)

Correspondence Address: DARBY & DARBY P.C., P. O. BOX 5257, NEW YORK, NY, 10150-5257, US

(21) Appl. No.: 10/970,364

(22) Filed: Oct. 21, 2004

Related U.S. Application Data
(63) Continuation of application No. PCT/ES03/00176, filed on Apr. 16, 2003.

(30) Foreign Application Priority Data
Apr. 22, 2002 (ES) PI200200928

(51) Int. Cl. A23L 2/00

(52) U.S. Cl. 426/66

(57) ABSTRACT

Flavoured/aromatized ice cubes, a method for their production and the use of the ice cubes produced. The cubes are characterized in that each cube comprises an ice cube mass formed by frozen water with flavouring (and optionally colouring) agents in variable proportions of substantially between 0.01% and 20% by weight of the mass of water to be frozen, for the compensation of the flavour (and optionally the colour) of a drink cooled by the introduction of the ice cubes in a manner such that the flavouring (and optionally colouring) agents are dissolved in the mass of the ice cubes or are incorporated in the cubes in the form of discrete bodies soluble in the liquid to be cooled.

### CROSS REFERENCE TO RELATED APPLICATION

This application is a continuation of International Patent Application Serial No. PCT/ES03/00176, filed Apr. 16, 2003, and claims the benefit of Spanish Application No. PI 200200928 filed Apr. 22, 2002 which is incorporated by reference herein. The International Application was published in Spanish on Oct. 30, 2003 as WO 03/089856 A1.

### DESCRIPTION

The present invention relates to ice cubes which have the novel and inventive characteristic that their flavour is controlled, enabling the desired flavour effect to be achieved; the invention also relates to a method for the production of the ice cubes, and to their use.

As is known, the use of cubes for cooling drinks is very widespread and consists simply of introducing ice cubes into the drink in order to reduce its temperature. However, it has the disadvantage that the cooling takes place by the dissolving of the ice which produces water which has the effect of diluting the flavour and colour of the drink to be cooled.

The present invention is intended precisely to overcome the above-mentioned disadvantage on the basis of a process similar to that for conventional cubes, but with the contribution of the novel concept of the cube not only as a cooling means but as a complement to the drink, supplying flavour to the drink or reinforcing the drink's own flavour; the field of application of the invention is that of the industrial plants concerned or small refrigeration machines, the invention disclosing cubes that are flavoured/aromatized by the introduction of a flavour component in various forms into the mass of the cube so that, when the cube dissolves in the drink to be cooled, the flavouring agent is incorporated in the drink. With the use of the ice cubes of the present invention, it is thus possible to compensate for the effect of the dilution of the flavour and optionally the colour of drinks cooled by this method, that is, it is possible to prevent the “watering-down” effect on drinks that are cooled by ice cubes.

French Patent 2 747 888 is aimed at a water composition for the preparation of refreshing drinks with high edulcorating power containing intense sweeteners in order to confer the sweet taste to all of the volume of the drink to be obtained as well as a flavouring action with the same objective.

U.S. Pat. No. 5,958,481 refers to a method of making novelty ice cubes forming an encased combination of a core ice cube with external layers covering the faces of the ice cube, which have citric acid and a food dye.

UK Patent application 2 369 610 for a method for dispensing a beverage was published after the filing of the prioriaty Spanish Patent application to the present PCT application and it is not detrimental to the novelty of this latter as the simple mention of flavoured ice cubes does not anticipate the present invention.

To achieve its objects, the present invention provides, preferably, for the production of ice cubes starting with a solution of the desired flavouring agents in water so that the ice cube incorporates the flavouring agent in order to compensate for the usual effect of dilution of the drink once the cubes have dissolved in the drink to be cooled, so that the flavour of the drink is enhanced with the desired intensity and is not affected by the reduction in flavour which is brought about by simply increasing the amount of water incorporated in the drink to be cooled.

The flavouring agent and optionally the colouring agent must, however, fulfil the essential condition that it should be soluble in water and will be selected in various forms according to the purpose of the cubes. Thus, for example, the flavouring agent will vary if the cubes are intended for fruit juices, for example, orange juice, lemon juice, or the like, or for drinks of other types. The cubes will therefore be produced specially for a predetermined type of drink and will be sold for that purpose. Another condition to be fulfilled is that all of the additives to be added (flavourings, fruit-juice concentrates, sugars, sweeteners, flavour enhancers, natural or artificial additives, colourings, etc. . . ) should be for food use with corresponding health registrations and within prescribed proportions, if they are limited, in the case of colourings.

The flavouring agents may therefore be very variable and, for example, in the case of fruit juices, may be related fruit acids such as citric acid, ascorbic acid, lactic acid, or any flavour enhancer (natural or artificial). It is also possible to introduce flavouring essences into drinks of other types and to introduce sugar, or synthetic sweeteners. All of these are used upon the condition that they should be soluble in water and should not lower the freezing point of the water too much to permit industrialization.

Although the preferred solution will consist in introducing soluble flavouring agents into water and subsequently freezing the water in special ice-cube producing machines, it is also possible to introduce the flavouring agents in the form of small soluble bodies such as gelatine capsules or the like into the water or into the ice cubes during their formation, possibly giving them a highly original decorative finish; the small bodies introduced may also have the shape of the fruit from which the juice is made, for example a lemon, an orange, or the like, or any decorative shape, either colourless or with a desired colour generally corresponding to the colour of the drink which is to be cooled and the dilution of which is to be avoided.

The present invention is therefore based on the introduction into the cube of flavouring (and optionally colouring) elements which are intended to compensate for the diluting effects of conventionally known cubes made from water.

In most cases, a sweet and/or sour flavour effect will be introduced into cubes intended for refreshing drinks although the dilution-correcting effect may extend to other flavours and to other drinks, including alcoholic drinks, with the introduction of specific flavouring essences.

Although the present invention is not limited to any particular ice-cube production process, preferably, a method will be used in which, starting with tap water or water that has been desalinated by osmosis or other processes, the flavouring agent is dissolved in the same in a tank provided with a stirrer into which the flavouring agents are supplied, the level of flavouring agents being controlled automatically within predetermined limits; the solution is then transferred automatically by impulsion by a pump to an industrial cube-producing freezer and the cubes produced are then supplied to a conveyor system with an endless belt, channels, or the like and, finally, are transferred for packaging. Although the addition of the flavouring agents will preferably take place in the main dilution tank, if capsules or small soluble objects carrying the flavouring agents are to be incorporated, they will have to be incorporated, according to their nature, either in the main tank itself or directly in the industrial cube-producing apparatus.

The present invention also extends to the use of the cubes produced to the cooling of drinks with compensation for the effect of dilution of the flavour (and optionally the colour) that is brought about by the dissolving of the cubes.

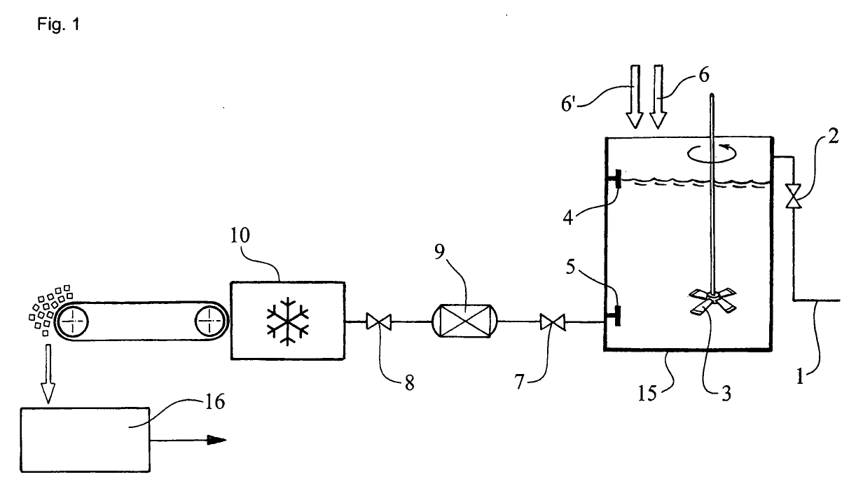

FIG. 1 is a diagram of the cube-production process of the invention.

As will be appreciated from the diagram, the present invention may involve, by way of example, an installation in which water from the mains, or water treated by osmosis or of another type is introduced into a tank 15 through piping 1, by means of an inlet-control solenoid valve 2, in order to maintain a predetermined level. The level is preferably monitored by means of full-level and empty-level sensors 4 and 5 which operate by closing and opening the valve 2, respectively, in order to maintain a predetermined level in the tank 15, which includes a stirrer device 3, keeping the liquid in the tank, with the additives which are supplied to the tank, for example, as indicated symbolically by the arrows 6 and 6′, in the desired quantities and colour in order subsequently to achieve the compensation of the flavour and colour characteristics of the drink to be cooled. The liquid contained in the tank 15 is transported, by means of piping with intermediate valves 7 and 8 and a force pump 9, to industrial cube-producing machines 10 from which the cubes produced will be transferred to a system of conveyor belts, guide channels, or by gravity or by means of vibrations or another system, finally being transferred to a packaging and storage section 16 and from there to transportation.

The additives added to the tank 15 will be of the desired nature for the flavour (and optionally colour) compensation of the drinks to be cooled and, as indicated, can preferably be dissolved in the water held in the tank 15 or may be constituted by small capsules or objects which, for example, have previously been frozen or shaped from soluble substances and which can be incorporated in the cubes with a uniform or individual distribution. According to circumstances, they may be incorporated in the tank 15 or directly in each cube in the cube-producing machines 10.

The present invention therefore extends not only to the flavour-control cubes but also to the production method indicated and also to the use of the above-mentioned cubes for controlling flavour (and optionally colour) in the cooling of drinks with flavour (and optionally colour) compensation.

Although it is not desired to limit in any way the proportions and flavour components to be used in the present invention, some examples will be given below. Thus, for example, the aqueous starting liquid for producing the cubes may be composed of: 100 parts of water, 10 parts of lemon juice, 8 parts of sugar, and one part of mint, or 100 parts of water, 10 parts of pineapple juice, 8 parts of sugar, and one part of mint, or even 100 parts of water, 5 parts of pineapple juice, 5 parts of lemon juice, 8 parts of sugar, and one part of mint.

Similarly, it is possible to incorporate 100 parts of water, 10 parts of lemon, one part of mint, and 0.1 part of sweetener, which could be replaced by 10 parts of pineapple juice or 5 parts of lemon juice with the addition of 5 parts of pineapple juice, one part of mint, and one of sweetener.

The invention also provides for 10 parts of lemon juice, 8 parts of liquid caramel and one part of mint, always maintaining the incorporation of 100 parts of water as a common denominator.

In another embodiment, 10 parts of pineapple juice, 8 parts of liquid caramel, and one part of mint will be added to 100 parts of water.

In another embodiment, 5 parts of lemon juice, 5 parts of pineapple juice, 8 parts of caramel, and one part of mint will be added to 100 parts of water.

In another embodiment, 10 parts of lemon juice and 8 parts of sugar are added to the water.

In an eleventh embodiment, 10 parts of lemon juice and 0.1 part of sweetener will be added to the water.

In a twelfth embodiment, 10 parts of pineapple juice and 8 parts of sugar are added to the water.

In a thirteenth embodiment, 10 parts of pineapple juice and 0.1 part of sweetener are added to the water.

In a fourteenth embodiment 5 parts of lemon juice, 5 parts of pineapple juice, and 8 parts of sugar are added to the water.

In a fifteenth embodiment, 5 parts of lemon juice, 5 parts of pineapple juice, and 0.1 part of sweetener are added to the water.

In a sixteenth embodiment, 10 parts of lemon juice and 8 parts of caramel are added to the water.

In a seventeenth embodiment, 10 parts of pineapple juice and 8 parts of caramel are added to the water.

In an eighteenth embodiment, 5 parts of lemon juice, 5 parts of pineapple juice, and 8 parts of liquid caramel are added to the water.

In a nineteenth embodiment, 10 parts of lemon juice, 5 parts of sugar and 3 parts of liquid caramel are added to the water.

In a twentieth embodiment 10 parts of lemon juice and 0.1 parts of sweetener are added to the water.

In a twenty-first embodiment, 10 parts of pineapple juice, 5 parts of sugar, and 3 parts of liquid caramel are added to the water.

In a twenty-second embodiment, 10 parts of pineapple juice and 0.1 parts of sweetener are added to the water.

In a twenty-third embodiment, 5 parts of lemon juice, 5 parts of pineapple juice, 5 parts of sugar, and three parts of liquid caramel are added to the water.

In a twenty-fourth embodiment, 5 parts of lemon juice, 5 parts of pineapple juice, and 0.1 of sweetener are added to the water.

In a twenty-fifth embodiment, 10 parts of lemon juice are added to the water.

In a twenty-sixth embodiment, 10 parts of pineapple juice are added to the water.

In a twenty-seventh embodiment, 5 parts of lemon juice and 5 parts of pineapple juice are added to the water.

In a twenty-eighth embodiment, 10 parts of lemon juice, 5 parts of sugar, 3 parts of caramel and one part of mint are added to the water.

In a twenty-ninth embodiment, 10 parts of pineapple juice, 5 parts of sugar, 3 parts of caramel and one part of mint are added to the water.

In a thirtieth embodiment, 5 parts of pineapple juice, 5 parts of lemon juice, 5 parts of sugar, 3 parts of caramel, and one part of mint are added to the water.

In a thirty-first embodiment, 8 parts of sugar, and 0.1 parts of vanilla or vanilla flavouring are added to the water.

In a thirty-second embodiment, 5 parts of lemon, 5 parts of lime, and 0.1 parts of flavouring are added to the water.

In a thirty-third embodiment, 5 parts of lime, 1 part of citric acid, 0.1 parts of flavouring are added to the water.

In a thirty-fourth embodiment, 8 parts of pineapple juice, 8 parts of sugar, 0.5 of citric acid and flavourings are added.

In a thirty-fifth embodiment, 1 part of citric acid, 0.1 parts of colouring, and 0.1 parts of flavouring are added.

In a thirty-sixth embodiment, 1 part of citric acid, 4 parts of sugar, and 0.1 parts of colouring and 0.1 parts of flavouring are added.

In a thirty-seventh embodiment, 2 parts of citric acid and 0.1 parts of flavouring are added.

In a thirty-eighth embodiment, 2 parts of citric acid, 8 parts of sugar, 0.1 parts of flavourings and 0.1 parts of sweetener are added.

In a thirty-ninth embodiment, 2 parts of citric acid, 0.1 parts of sweetener, 0.1 parts of flavourings, and 0.1 parts of colouring are added.

In a fortieth embodiment, 2 parts of citric acid, 8 parts of caramel, 0.1 parts of flavourings, and 0.1 parts of sweetener are added.

In a forty-first embodiment, 0.1 parts of flavourings.

In general, the flavouring (and optionally colouring) agents are incorporated in variable proportions substantially of between 0.01% and 20% by weight of the total water to be frozen in order to compensate the flavour (and optionally the colour) of the drink cooled by the introduction of the ice cubes.

1. Flavoured/aromatized ice cubes, characterized in that each cube comprises an ice-cube mass formed by frozen water with flavouring (and optionally colouring) agents in variable proportions of substantially between 0.01% and 20% by weight of the mass of water to be frozen, for the compensation of the flavour (and optionally the colour) of a drink cooled by the introduction of the ice cubes.

2. Flavoured/aromatized ice cubes according to claim 1, characterized in that the flavouring (and optionally colouring) agents are dissolved in the mass of the ice cubes.

3. Flavoured/aromatized ice cubes according to claim 1, characterized in that the flavouring (and optionally colouring) components are incorporated in the cubes in the form of discrete bodies soluble in the liquid to be cooled.

4. Flavoured/aromatized ice cubes according to claim 1, characterized in that the flavouring agents are fruit-juice concentrates.

5. Flavoured/aromatized ice cubes according to claim 1, characterized in that the flavouring agents are essential oils or flavourings, sugars, sweeteners, flavour enhancers, artificial or natural flavouring additives, colourings and the like.

6. Flavoured/aromatized ice cubes according to claim 3, characterized in that the discrete bodies carrying the flavouring agents have an external structure and colour similar to the fruits of juices to be cooled.

7. Use of the cubes according to claim 1 for cooling drinks with compensation for the effect of dilution of the flavour (and optionally the colour) that is brought about by the dissolving of the cubes.
